(19) United States
(12) Patent Application Publication
(10) Pub. No.: US 2018/0317024 A1
(43) Pub. Date: Nov. 1, 2018

(54) Method for Operating a hearing Aid and Hearing Aid operating according to such Method

(71) Applicant: Sonova AG, Staefa (CH)

(72) Inventor: Hans-Ueli ROECK, Hombrechtikon (CH)

(73) Assignee: Sonova AG, Staefa (CH)

(21) Appl. No.: 15/770,235

(22) PCT Filed: Nov. 24, 2015
(86) PCT No.: PCT/EP2015/077508

§ 371 Date: Apr. 23, 2018

(51) Int. Cl. H04R 25/00; H04B 1/3827

(52) U.S. Cl. CPC H04R 25/43; H04B 1/385; H04R 2225/43; H04R 25/505; H04R 2225/025; H04R 25/554

(57) ABSTRACT

The present invention relates to a method of operating a hearing aid (1), comprising the steps of receiving (100; 101) ambient audio information (20) by at least one microphone (2) of the hearing aid (1), to provide an ambient audio signal (20s); and an alternative audio information (30) by at least an interface unit (3) of the hearing aid (1), to provide an alternative audio signal (30s), wherein the alternative audio information (30) is transmitted by an alternative audio source (8). The present method comprises additionally the steps of weighting the alternative audio signal (30s) and the ambient audio signal, to form a weighted alternative audio signal (110) and a weighted ambient signal (109), respectively; mixing (111) the weighted alternative audio signal and the weighted ambient audio signal to produce a combined audio signal; generating (112) an output signal based on the combined audio signal; and supplying (112) an output signal to a receiver (5) of the hearing aid (1). The weighting step further comprises determining a first weight (108) for forming the weighted alternative audio signal (110) and a second weight (106) for forming the weighted ambient signal (109), wherein the first weight and the second weight are based on a sound level difference (102, 103, 104) between the sound level of the alternative audio signal (30s) and the sound level of the ambient audio signal (20s). The present invention also relates to a hearing aid (10) configured to operate according to the above method.

The present invention relates generally to hearing aids, particularly to a method of operating a hearing aid and to a hearing aid operating according to such a method. More specifically, the method according to the present invention is designed to achieve a weighted mixing of an ambient audio signal, provided by a microphone of a hearing aid, and of an alternative audio signal, transmitted by an alternative audio source, in a way that best reflects the given hearing situation and contextually prioritizes the hearing intention of the hearing aid users.

In the following, the term hearing aid shall be understood as a device to be worn at the vicinity or directly within the ear of a person to improve the individual hearing capacity of this person. Such an improvement may include the prevention of the receiving of certain acoustic signals in terms of ear protection.

In relation to their application and user indication, and according to the corresponding main solutions available on the market, such hearing devices can be worn, for instance, behind the ear (BTE), within the ear (ITE) or completely within the ear canal (CIC). The latest design developments have made available hearing devices that are even smaller than completely within the ear canal (CIC) devices, aptly named invisible in the canal (IIC) hearing aids.

It will be recognized that the inventive features of the present invention are substantially compatible with any style of hearing aids, including the above mentioned models, as well as with hearing aids which are eyewear-mounted, implanted, body-worn, etc.

Hearing aids normally comprise at least one microphone as acoustic input element; at least one speaker as acoustic output element; and an electronic processing element, connected with said microphone and said speaker, for the processing and manipulation of electronic signals. This electronic processing element may comprise analogue or digital signal processing devices. Said elements are usually arranged within at least one main case or shell of the hearing device.

Typically, the microphone acts as an electroacoustic transducer and receives acoustic signals, converts such signals into electrical signals and transmits them to the abovementioned electronic processing element.

The electronic processing element is part of a signal processing circuit which, normally, performs various signal processing functions. Such signal processing functions can include amplification, background noise reduction, beamforming, feedback cancelling, frequency lowering, sound type classification, tone control, etc.

Normally, the signal processing circuit outputs an electrical signal to a speaker. The speaker acts as an electroacoustic transducer and converts the electrical signal from the signal processing circuit into an acoustic signal which is transmitted as audio into a user's ear. For a cochlea implant, the transducer is replaced by a set of electrodes which deliver electrical impulses directly to the hearing nerve.

The signal processing circuit of current hearing aids typically comprises a digital signal processor, or DSP, which can be programmed to execute the functional tasks of dedicated signal processing algorithms. In today's hearing aids, the DSP can operate according to several different algorithms comprising respective systems of instructions, rules and parameters for performing specific tasks relative to the processing of the input signal. Thanks to such algorithms, the signal can be manipulated to more closely comply with the acoustic needs of a user and in modern hearing aids not only amplification for compensating a hearing loss, filtering and compression are enabled, but also more complex functions are made possible, such as adaptive directional functions for reducing the sound levels from the sides and rear, automatic mode switching dependent on the nature of the input sound or calibration based on measurements for better fitting to the individual ear.

In order to execute the above signal processing algorithms, a programmable digital signal processor generally cooperates in operation with a non volatile memory for storing and retrieving data. Such data can comprise setting, measurement or calibration parameters and characteristics to be taken into account in executing the step-by-step set of signal processing operations performed by the DSP, and in general the set of rules and instructions corresponding to the signal processing algorithms, commonly designated as firmware.

Current hearing aids have one or more local microphones, in one of several possible directivity modes (e.g. omnidirectional, adaptive or static directional, etc.), gathering acoustic signals from the environment. Ambient audio information is therefore captured by such microphones that produce corresponding ambient audio signals.

It is also known to provide current hearing aids with additional interface units for gathering and receiving alternative audio signals, transmitted by alternative audio sources. Such alternative audio sources are generally distinct from the hearing aids and may be disposed remotely from the hearing aid users. Examples of such alternative audio sources can be Tele-coils, BlueTooth radios (BT), or radios of some proprietary nature, etc.

Alternative audio sources are known which transmit, typically wirelessly, alternative audio signals in different situations. Alternative audio signals can take the form of communication signals emitted by a remote talker in a phone conversation; or communication signals sent over an electromagnetic communication system, like induction loops, in e.g. churches, ticket counters, auditoriums; or media contents streamed from a TV, from a smart phone or a smart watch.

Current technology solutions for mixing ambient audio signals captured by hearing aid microphones with alternative audio signals normally use a fixed ratio to produce a combined audio signal, irrespective of the relevance of the alternative audio signals with respect to the ambient audio signals in a specific hearing situation.

The outcome of such simplistic approach is that the ambient signal is often somewhat, arbitrarily attenuated with respect to the streamed alternative audio signal.

A curt attenuation of the ambient signal as above explained is usually carried out by way of a selection, by the hearing aid user, of a function mode, or of a so-called streaming program, based on which the streamed signal from an alternative audio source is to be privileged. According to such a function mode, the alternative audio signal is accepted automatically when transmitted and received by an interface unit of the hearing aid and the ambient audio signal is attenuated by a predetermined amount. Other, slightly more elaborated prior art methods, which are not solving the problem significantly better, are briefly presented in the following.

WO 2010/086462 A2 discloses generating an output signal supplied to the output transducer of a hearing device by combining an audio signal of a transmission signal with an acoustic signal of an input transducer, based on a ratio determined as a function of the position, also angular, of a hearing aid user with respect to the sound source.

In the same patent document, U.S. Pat. No. 6,694,034 B2 is acknowledged, which discloses a hearing aid whose circuitry is able to select signals coming either from a primary audio source or from a secondary audio source for coupling. The criterion used for signal selection is purely the signal strength as detected. No considerations on the hearing situation and on the context are really used.

U.S. Pat. No. 8,565,456 B2 discloses a hearing aid comprising a microphone to acquire a sound from the environment and an external input terminal to acquire input sound from an external device. A mixer is provided to mix a corresponding sound signal inputted to the microphone and a corresponding sound signal inputted to the external input terminal. The mixing happens based on a mixing ratio which takes into account the detection, by a similarity calculator, of the correlation between the former two sound signals. The priority attributed to each of such sound signals is set to a mixing ratio which is a function of the correlation between the sounds, in a way that if the correlation is high, it is assumed that priority of the sound signal inputted from the external input terminal is to be raised. The mixing rule in U.S. Pat. No. 8,565,456 B2 resides therefore merely in a sound signal similarity measurement. As a consequence, the mixing ratio used, rigidly fixed to a set of definite values, is not based on the respective sound levels of the sound signal inputted to the microphone and of the sound signal inputted to the external input terminal.

Remote microphone systems are known which additionally take the environmental sound level and the voice activity as detected at the alternative audio source into account, in order to additionally boost/amplify the remote alternative audio signal (such as the voice of a remote talker at the remote microphone) over the ambient signal, to ensure that a decent signal to noise ratio results just for the remote alternative audio signal (or voice of the remote talker).

Such remote microphone systems do not take into consideration, though, specific, actual hearing situations that may arise during operation of a hearing aid and concurrent activity of an alternative audio source thereto coupled.

By way of example, the remote talker may be once in a while quiet and/or the hearing aid user might want to talk himself by answering a question or making a statement and/or the hearing aid user might want to listen to an answer given or a statement made by a nearby third person.

In these instances, ideally the ambient microphones should not be attenuated anymore -as instead it is the case for current hearing aids, coupled to remote communication systems, when “rigidly” set to a program for receiving alternative audio signals from remote. Also, ideally no additional gain should be applied to the alternative sound signal from the remote microphone, in the above described situation. A correlation measure as in the above prior art does not resolve such situations either.

Likewise, if a spouse starts talking to a hearing aid user intent in watching a movie with streamed audio, the hearing aid user will only want to have the TV provisionally muted—the same way as any non-hearing impaired user would do—without having to expressly change hearing aid programs in order to hear and understand the spouse.

As long as the ambient microphone signals remain attenuated on account of a rigid setting and/or only gains of alternative audio source signals get changed based upon signals levels, however, this is not the case.

Current technologies are also affected by the further drawback that the operation of amplifying an already loud voice, for instance of a remote talker, in an attempt to overcome the sound level in a busy environment or space (such as in a classroom), produces even louder signal levels of that voice at the input of a hearing aid.

An operation sequence as above described, automatically reinforcing in loops the amplification of a voice transmitted from remote by an alternative sound source so that it dominates over the perception of an ambient sound, adversely affects the effective functioning of a hearing aid, in that it pushes the hearing device to its functioning limits, namely, to its so called Max Power Output, otherwise designatable as MPO. As a consequence of this, all temporal cues get flattened out. The disappearance of these relevant temporal cues brings about the drawback that intelligibility (particularly, speech intelligibility) might even decrease. Moreover, the ensuing loud sounds are unpleasant and very tiring for a hearing aid user.

Thus, there exists a need for a method for operating a hearing aid which allows:
to effectively reflect, and deal with, dynamically changing hearing conditions, by adaptively determining the attenuation or amplification factors most suitable both
   to an alternative audio signal, transmitted to a hearing aid by an alternative audio source, and
   to an ambient audio signal picked up by a hearing aid microphone,
   in order to produce a combined audio signal which best represents the hearing intention of a hearing user at a given moment;
to reliably determine whether an ambient audio signal or an alternative audio signal is to be regarded as “target” signal as opposed to background “noise”, in the given hearing situation;
to advantageously and safely balance the need
   to ultimately provide, out of mixing an ambient audio signal and an alternative audio signal, a combined audio signal having good signal to noise ratio; and
   to avoid overly loud, uncontrolled and confusing signal levels that do not represent the hearing aid user's interest in a definite, clear perception of relevant information.

Accordingly, a major objective of the present invention is to provide a method for operating a hearing aid which guarantees that attenuation and/or amplification weights, or factors, are properly determined respectively for an alternative audio signal, transmitted to the hearing aid by an alternative audio source, and for an ambient audio signal, picked up by a microphone of the hearing aid, before such signals are mixed to produce a combined audio signal. The resulting combined audio signal should represent the interest of the hearing aid user in the given hearing situation and have optimized intelligibility, in function of the ambient conditions and of the remote communication.

These problems are solved by a method and a hearing aid according to the independent claims. Dependent claims further introduce particularly advantageous embodiments for such a method and device.

The inventive solution according to the present invention basically requires to configure a hearing aid to dynamically determine if an ambient audio signal or an alternative audio signal is a target audio signal, wherein dynamically determining said target audio signal comprises the steps of adjusting, either by attenuation or by amplification, the ambient audio signal and/or the alternative audio signal as a function of a sound level difference between the sound level of said alternative audio signal and the sound level of said ambient audio signal.

The operation of weighting the alternative audio signal and the ambient audio signal, to form a weighted alternative audio signal and a weighted ambient signal, respectively, is therefore based on a sound level difference between the sound level of the alternative audio signal and the sound level of said ambient audio signal.

As a consequence of the above innovative approach according to the present invention, signals from an alternative audio source and signals representative of an ambient sound detected by a hearing aid microphone are processed in a way that:
when the alternative audio source is active, a proportionate signal to noise ratio for such signal is ensured with respect to the ambient audio signal;
when the alternative audio source is not active and it is determined that the ambient audio signal is the “target” signal, the ambient audio signal is fully reproduced;
neither the alternative audio signal nor the ambient audio signal are perceived as too loud by the hearing aid user;
for intermediate cases when both alternative audio source and ambient sounds are detected, the relative importance of the signals is inferred based on a sound level difference between the sound level of said alternative audio signal and the sound level of said ambient audio signal;
ultimately, not the absolute value of an ambient audio signal at the location of an alternative sound source or e.g. a similarity correlation between an alternative and an ambient audio signal is the prime factor, but the relative differences of ambient and alternative audio signals at the hearing aid are used as the leading parameter for producing mixing factors for both alternative and ambient audio signals. Absolute signal levels might only be used to further influence the weighting factors in very loud or very quiet environments.

According to the present invention, a possible attenuation or amplification of a hearing aid microphone, as well as attenuation or amplification of an alternative audio source, are made dependent on the difference between the sound level of said alternative audio signal and the sound level of said ambient audio signal.

The adjustment made to an ambient signal picked up by a hearing aid microphone is therefore also made dependent on the sound level of the alternative sound source, while the ambient audio signal level is itself referenced in the adjustment operated on the alternative audio signal level.

Vice versa, the adjustment made to a signal transmitted by an alternative sound source is made dependent on the sound level of the ambient, and especially on the ambient audio signal adjusted by a mixing factor, while the alternative audio signal level is itself referenced in the adjustment operated on the ambient audio signal level.

Another advantage of the present invention resides in the fact that an automatic attenuation of the ambient microphone can be disabled when the hearing aid user starts talking, so that the hearing aid user properly understands his own talking.

Other objectives, features and advantages of the present invention will be now described in greater detail with reference to specific embodiments represented in the attached drawings, wherein:

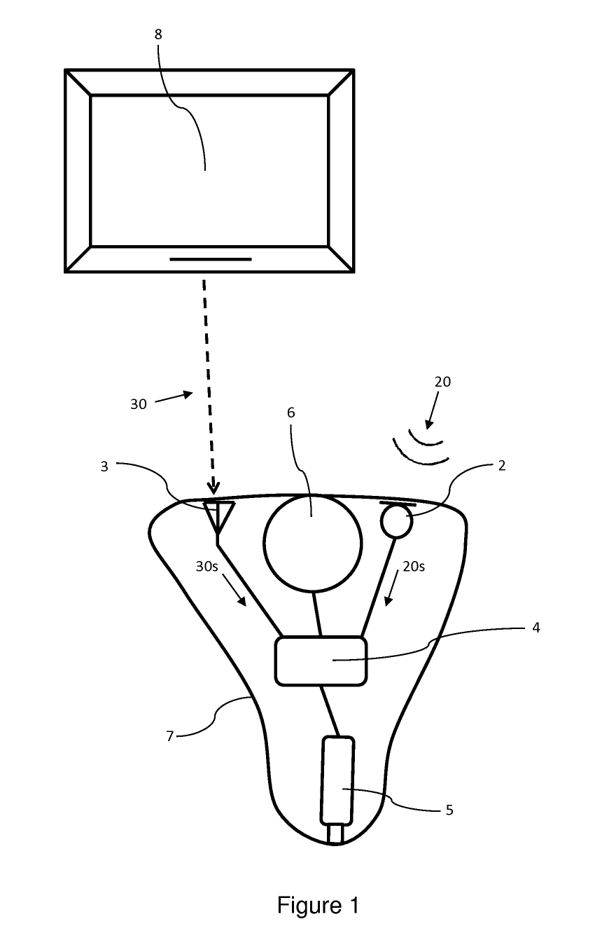

FIG. 1 is a schematic representation of a hearing aid configured to function according to the operating method of the present invention;

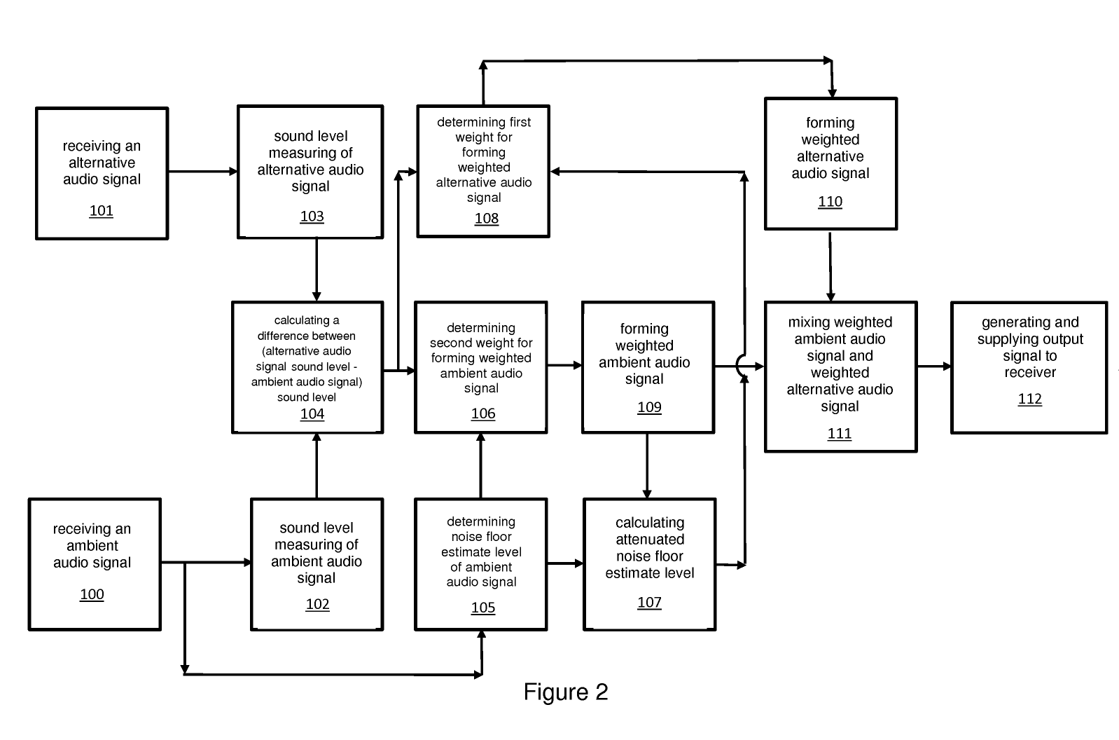

FIG. 2 is a schematic representation of a sequence of steps for an embodiment of the method of operating a hearing aid according to the present invention.

With reference to FIG. 1, a hearing aid 1 operating according to a method of the present invention preferably comprises at least one microphone 2 configured to receive ambient audio information 20 and to provide a corresponding ambient audio signal 20s; as well as at least an interface unit 3 configured to receive an alternative audio information 30, transmitted by an alternative audio source 8, and to provide a corresponding alternative audio signal 30s.

The interface unit 3, depending on the nature of the alternative audio signal received, can take the form of a radio including a respective antenna -such as a Bluetooth radio or a radio suitable for receiving some other radio transmission, also of proprietary nature- or the form of a tele-coil electromagnetically picking up the audio signal, or similar.

The alternative audio source 8 emitting the alternative audio information 30 can be, by way of example, an audio induction loop system, transmitting the voice of a speaker or talker, in some public context, like in a church, at a ticket counter, in a school classroom during a lesson or in an auditorium during a performance. Such an audio induction loop system can easily couple with a tele-coil as above introduced. The alternative audio source 8 can also be a radio set or television set, a smart phone or a wearable smart device streaming media content. The alternative audio source 8 is preferably distinct from the hearing aid 1.

FIG. 1 schematically represents a within the ear (ITE) hearing aid 1, just by way of exemplification. At any rate, any other model of hearing aid as presented in the introduction can be modified and configured to operate according to the method of the present invention.

As represented, the hearing aid 1 comprises, within a casing 7, an audio signal processing unit 4, which is configured to generate an output signal and supply it to a receiver 5. Preferably, an energy storage device 6, such as a battery or accumulator, powers the electronic components of the hearing aid 1, including the audio signal processing unit 4.

With reference to the embodiment represented in FIG. 2, a method of operating a hearing aid 1 according to the present invention is substantially performed by functions integrated in the signal processing unit 4. Such method comprises a step of receiving ambient audio information 20 by at least one microphone 2 of the hearing aid 1. Thus, the microphone 2 provides a corresponding ambient audio signal 20s to the signal processing unit 4, as represented at a step 100. Said step 100 might also involve e.g. beamforming of any kind.

The present method also comprises a step 101 of receiving, by the signal processing unit 4, an alternative audio signal 30s from at least an interface unit 3 of the hearing aid 1. Alternative audio information 30, corresponding to the alternative audio signal 30s, is originally transmitted by an alternative audio source 8 to the interface unit 3, as exemplified in FIG. 1.

The step 100 of receiving an ambient audio signal 20s and the step of 101 of receiving an alternative audio signal 30s, by the signal processing unit 4, can be concurrent or differently synchronized or, otherwise, offset in time.

The method according to the present invention comprises further steps of weighting the abovementioned alternative audio signal 30s and the ambient audio signal 20s, to respectively form a weighted alternative audio signal, as shown at step 110, and a weighted ambient signal, as shown at step 109.

As exemplified at step 111 of FIG. 2, in the method according to the present invention follows a step of mixing the weighted alternative audio signal and the weighted ambient audio signal, in order to produce a combined audio signal.

Based on such combined audio signal, an output signal is then generated by the signal processing unit 4 and supplied to a receiver 5 of the hearing aid 1, as schematically exemplified at step 112. Said step 112 might also involve other signal processing such as amplification, feedback cancelling, frequency lowering, sound type classification etc.

Weighting the alternative audio signal 30s comprises a step 108 of determining a first weight for forming the weighted alternative audio signal of step 110. Weighting the ambient audio signal comprises a step 106 of determining a second weight for forming the weighted ambient signal of step 109.

Differently from the solutions currently adopted in the prior art, the method of operating a hearing device according to the present invention relies on making the weights, or weighting factors, for the audio signals to be mixed dependent on a dynamic relationship between the alternative audio signal 30s and the ambient audio signal 20s, so that the actual hearing circumstances are more appropriately captured and a better response is provided conforming to the hearing intention of the hearing aid user. Accordingly, the present method dynamically determines if the ambient audio signal or the alternative audio signal is a target audio signal in the given hearing context.

In fact, the first weight and the second weight in the present method are based on a sound level difference between the sound level of the alternative audio signal 30s and the sound level of the ambient audio signal 20s.

As exemplified in the embodiment of FIG. 2, the method according to the present invention preferably comprises a step 102 of measuring the sound level of the ambient audio signal 20s.

The method according to the present invention also preferably comprises a step 103 of measuring the sound level of the alternative audio signal 30s.

The sound level difference between the sound level of the alternative audio signal 30s and the sound level of the ambient audio signal 20s can therefore be calculated, as represented in step 104 of FIG. 2.

As a function of the sound level difference, the ambient audio signal and/or the alternative audio signal 30s can be adjusted, either by attenuation or by amplification.

In a preferred embodiment, though not exclusively, a first weight can be determined that adjusts the alternative audio signal 30s by applying a gain, thus forming an amplified weighted alternative audio signal at step 110; whereas a second weight can be determined that adjusts the ambient audio signal by way of attenuation, thus forming an attenuated ambient signal at step 109.

As shown by way of exemplification at step 105 and 106 of FIG. 2, the signal processing unit 4 can also determine a noise floor estimate level, for instance out of the amplitude-frequency spectrum of the ambient audio signal. In this case, the determination of the second weight for forming a weighted ambient signal at step 106 can result both from the basic component of the difference between the sound level of the alternative audio signal and the sound level of the ambient audio signal, as calculated at step 104; and from the further component of the noise floor estimate level.

The noise floor estimate level of the ambient audio signal 20s can also be taken into account when determining the first weight for forming the weighted alternative audio signal 30s.

More specifically, and as shown in FIG. 2, the method according to the present invention can comprise the step of attenuating, at step 109, the ambient audio signal, by applying an attenuation which is a function of the second weight determined at step 106. As a result of this operation, an attenuated ambient audio signal is derived to which is associated an attenuated noise floor estimate level.

The first weight for weighting the alternative audio signal 30s can be made a function of both the basic component of the difference between the sound level of the alternative audio signal and the sound level of the ambient audio signal, as calculated at step 104; and of the above mentioned attenuated noise floor estimate level, as calculated at step 107. This way, it is guaranteed that a gain is applied to the alternative audio signal just to the extent that an optimal signal to noise ratio is provided, while attenuating an ambient audio signal as long as reasonable.

It is evident from the sequence of steps described above, to be carried out by dedicated algorithms in the signal processing unit 4, that the present invention avoids to use a fixed ratio, a simple signal level or a similarity correlation to produce a combined audio signal and takes into account the relevance of alternative audio signals with respect to ambient audio signals, in a specific hearing situation.

As already noted, the adjustment made on an ambient signal picked up by a hearing aid microphone is therefore also made dependent on the sound level of the alternative audio signal, while the ambient audio signal level—as well as the attenuated ambient audio signal level, e.g. the noise floor estimate thereof—is itself referenced in the adjustment operated on the alternative audio signal level.

Vice versa, the adjustment made on a signal transmitted by an alternative sound source is made dependent on the sound level of the ambient.

Based on a main framework provided by the work-flow as above described—wherein a possible attenuation or amplification of a hearing aid microphone and/or of an alternative audio source are made dependent on the difference between the sound level of said alternative audio signal and the sound level of said ambient audio signal—several specific processes for the automatic adjustment of ambient audio signals and alternative audio signals prior to the mixing thereof can be implemented.

In a possible embodiment, after comparing the levels of the ambient audio signal 20s and of the alternative audio signal 30s, the method according to the present invention can comprise the step of attenuating the ambient audio signal, under the condition that the sound level of the alternative audio signal 30s is louder than the sound level of the ambient audio signal. It is assumed in this case that the alternative audio signal 30s is the target signal in this instance.

In an alternative embodiment, the method according to the present invention can additionally comprise the step of attenuating the ambient audio signal 20s when the alternative audio source emits an alternative audio signal 30s whose sound level is higher than a first minimum threshold value.

Else, if the sound level of the ambient audio signal 20s keeps louder than the sound level of the alternative audio signal 30s, the method according to the present invention preferably does not attenuate the ambient audio signal. In this further instance, it is preferable that no additional gain is applied to the alternative audio signal. This is in line with an assumption that, for instance, an alternative sound source is not currently active or is not the target signal anyhow. By way of example, in the context of a public discussion or seminar, a remote talker whose voice is streamed via an alternative audio source 8 might be quiet at a given moment and a hearing aid user might want to answer a question or make a statement or, yet again, listen to the contribution of a third neighbouring person, proximate to his own location. In such a hearing situation, the audio signal coming from the ambient microphone of the hearing aid will not be attenuated anymore, in compliance with the demand of the hearing aid user of having a clear perception of his own voice or of the voice of the neighbouring third person.

Also, the method according to the present invention can comprise applying no attenuation to the ambient audio signal when the sound level of the ambient audio signal is higher than the sound level of the alternative audio signal by a second minimum threshold value.

The method according to the present invention can comprise the step of setting an attenuation of the ambient audio signal to a value that is additionally a function of the noise floor estimate level of the ambient audio signal, according to the following rules:
if the noise floor estimate level exceeds a first given threshold value, the ambient microphone attenuation applied shall increase proportionally by an additional amount; and/or
if the noise floor estimate level keeps below a second given threshold value, an additional ambient microphone attenuation is not applied.

Therefore, in case the noise floor estimate level exceeds a first given threshold value, the algorithm can thus prevent, by application of an extra amount of attenuation, that signals get to a level of discomfort for the hearing aid user.

The noise floor estimate level itself is determined by one of well known methods, e.g. by minimum statistics where the minima of a suitably averaged signal envelope are taken as the noise floor estimates.

The method according to the present invention can comprise the step of applying a gain increment to the alternative audio signal 30s, when it is determined that the sound level of the alternative audio signal is higher than the sound level of the ambient audio signal, particularly if the noise floor estimate level of the attenuated ambient audio signal exceeds a minimum threshold value.

The provision of this functionality is, for instance, beneficial in a hearing context such as a loud classroom, wherein the alternative audio signal is emitted by a teacher. It advantageously takes into account the actual environment conditions, by preferably evaluating the noise floor estimate level and tailoring a possible, corresponding gain increment thereto, consequently avoiding any excess in unduly amplifying the alternative audio signal.

By way of a non-limiting example, a specific embodiment of the present invention is introduced in the following which illustrates how an algorithm may be implemented according to the present method to produce weighting factors for forming weighted ambient audio signals and weighted alternative audio signals. The following Matlab code lines also clarify on the mutual dependence between the process aimed at forming a weighted alternative audio signal at step 110, and the process aimed at forming a weighted ambient signal at step 109.

AAS_Amb_SNR=AAS_Level—AmbientL;

Mic_atten=max(min(0,−AASAmbSNR),Max_Att_Mic−max(K1*(Ambient NFE−K2)));

Att_NFE_level=Min_Statistics (abs(Mic_atten* AmbientSignal);

AAS_Gain=min(max(0,AAS_Amb_SNR), AASgainParam* (max(K3,min(K4,Att_NFE_level))−K5));

Clearly, in the first equation a sound level difference between the sound level of an alternative audio signal and the sound level of an ambient audio signal is obtained.

In the second equation, a microphone attenuation is obtained that can be used for applying a second weight as claimed to the ambient audio signal and adjust it to form a weighted ambient audio signal. In this instance, the weighted ambient audio signal comes to be an attenuated ambient audio signal. It is evident how the microphone attenuation via said second weight is based not only on the previously calculated sound level difference, but also on a noise floor estimate level of the ambient audio signal.

Synthetically, in the second equation the microphone attenuation is given by the maximum between a first and a second quantity. The first quantity is given as the minimum between 0 and the opposite of the sound level difference as introduced in the first equation. The second quantity is given as the difference between a pre-defined maximal value admissible for the microphone attenuation and the maximum of a function given by a scaling factor, k1, multiplied by the difference between the noise floor estimate level of the ambient audio signal and a bias parameter, k2, representing a bias sound level.

The attenuated ambient audio signal, obtained by attenuating the ambient audio signal in function of said second weight, is characterized by an attenuated noise floor estimate level which is given in the third equation. In the third equation, the attenuated noise floor estimate level is derived by applying an operator representing the running minimum of an audio signal level envelope to the absolute value of the result of the multiplication of the actual ambient audio signal as picked up by the microphone by the microphone attenuation calculated in the second equation.

In the fourth equation, a gain for the alternative audio signal is obtained that can be used for applying a first weight as claimed to the alternative audio signal and adjust it to form a weighted alternative audio signal. In this instance, the weighted alternative audio signal comes to be an amplified alternative audio signal.

As it can be derived from the fourth equation, such gain is function of the previously calculated sound level difference, and also of the attenuated noise floor estimate level derived in the third equation.

Synthetically, in the fourth equation the gain for the alternative audio signal is given by the minimum between a first and a second quantity.

The first quantity is given as the maximum between zero and the sound level difference as introduced in the first equation.

The second quantity is given by the maximum between a lower level threshold parameter, K3, and the minimum between two sub-quantities. The first sub-quantity is an upper level threshold parameter, k4. The second sub-quantity is the attenuated noise floor estimate level derived in the third equation. The maximum of such second quantity is then subtracted by a value equal to said lower level threshold parameter, K3; and the result of such operations further multiplied by a scaling factor of the gain represented by “AAS_gainParam”.

When the alternative audio signal is deemed more important than the ambient audio signal, according to the rules explained above, the first weight adjusts the alternative audio signal 30s to form said weighted alternative audio signal 110 by applying a gain. A further, additional gain can be applied on top in case of loud ambient noise floor estimate level. In specific situations, such further, additional gain is applied just under the condition that the alternative audio signal is slightly louder (e.g. by a maximum threshold) than the ambient signal, as in such cases an additional gain provides the best benefit to the hearing aid user. For alternative audio signals which are themselves significantly louder than an ambient audio signal, no further, additional gain is needed.

In a specific embodiment, when the ambient audio signal is deemed more relevant than the alternative audio signal, according to the rules above explained, the method according to the present invention can comprise a step of applying a gain decrement to the alternative audio signal, when it is determined that the difference of the sound level of the ambient audio signal and of the alternative audio signal exceeds a minimum threshold value.

Such a gain decrement of the alternative audio signal can be preferably triggered when the ambient signal level is just slightly higher than the alternative audio signal level. This configuration is especially advantageous in hearing situations where the ambient audio signal needs to be prioritized, such as when a hearing aid user intends and/or starts to talk himself over the emission of some alternative audio source and it is desirable that he hears his own voice.

All of, or a portion of, the abovementioned threshold values, parameters and variables playing a role in adjusting the signal levels (either in the sense of amplification or in the sense of attenuation) in compliance with the processes of the present invention can be made configurable by a hearing aid user, for instance through a tactile user control on the hearing aid or from remote through a remote user control, such as a control application on a smartphone or on a wearable device. Such threshold values, parameters and variables can also be made configurable by a hearing care professional through a fitting application.

For instance, in some embodiments the measure of the sound level of the ambient audio signal, at step 102, can be set to be equivalent to the measure of the noise floor estimate level of the ambient audio signal, at step 105.

Also, the method according to the present invention can be implemented in a way that the first weight and the second weight are determined based on a sound level difference between the ambient audio signal and the alternative audio signal, offset by some bias level.

Such bias level can be set in a way that an attenuation of the ambient microphone is applied even when the sound level of the ambient audio signal is larger than that of the alternative audio signal. Such a special setting could reflect the intention of the user to attribute anyhow a higher importance to the alternative audio signal, which is accordingly prioritized over the ambient audio signal.

In order to enhance the conformity of the operation of a hearing aid according to the present invention to the actual hearing circumstances and to the real needs of a hearing aid use, the sound level of the alternative audio signal and the sound level of the ambient audio signal are preferably both detected at the hearing aid.

The audio signal level estimates, the audio signal level difference and/or the weighting factors might get averaged with a digital signal averager using suitable attack- and release time constants in order to achieve a perceptually pleasing function. Preferably, the time constants are in the range of 1 millisecond to 10 seconds; and even more preferably between 10 millisecond and 1 second.

The parameters leading to the actual weighting functions might also get influenced by automatic classification means, e.g. sound type classification means and/or source type classification means. Thus, for different sound types and/or different alternative audio sources, the gain and attenuation functions of the weighting factors might get adapted accordingly. By way of example, the gain function for an alternative audio signal coming from a remote microphone used in a classroom situation might be weighted stronger, in certain sound level difference conditions, than that for a TV audio signal. The reason is that the remote microphone is likely used by a teacher and the corresponding communication might be more relevant to hear, in the same sound level difference condition, than that coming from a TV, for instance in a domestic context when a spouse tries to talk to a hearing aid user.

The present invention also relates to a hearing aid 1 configured to operate according to the method above described.

Such hearing aid 1 comprises at least one microphone 2 configured to receive ambient audio information 20 and to provide an ambient audio signal 20s; and at least an interface unit 3 configured to receive an alternative audio information 30 transmitted by an alternative audio source 8 and to provide an alternative audio signal 30s.

An audio signal processing unit 4 of the hearing aid 1 comprises a weighting unit, or a weighting function, configured to weight the alternative audio signal 30s and the ambient audio signal 20s, in order to form a weighted alternative audio signal and a weighted ambient signal, respectively.

The audio signal processing unit 4 also comprises a mixing unit, or a mixing function, configured to mix the weighted alternative audio signal and the weighted ambient audio signal, to produce a combined audio signal.

The audio signal processing unit 4 is configured to generate an output signal based on said combined audio signal.

The hearing aid 1 further comprises a receiver 5 configured to be supplied with the above output signal.

The weighting unit, or weighting function, in the signal processing unit 4 is configured to determine a first weight for forming the weighted alternative audio signal and a second weight for forming the weighted ambient signal. The first weight and the second weight are based on a sound level difference measured between the sound level of the alternative audio signal 30s and the sound level of the ambient audio signal 20s.

The present invention allows to automatically tailor the relative adjustment of alternative audio signals and of ambient audio signals to the actual hearing situation, without the need for a hearing aid user to actively initiate a commutation between hearing aid programs as a result of the onset of perceived discomfort. The present invention also balances the need for an optimal signal to noise ratio with the need to avoid providing signals with overly loud sound levels.

1-18. (canceled)

19. A method to operate a hearing device, the method comprising:
receiving wirelessly an ambient audio signal from a remote audio source;
receiving a local audio signal, wherein the local audio signal is associated with a microphone physically coupled to a hearing device;
determining a first weight for the ambient audio signal and a second weight for the local audio signal based on a sound level difference between the ambient audio signal and the local audio signal,
wherein the first and second weights are dynamic;
mixing the ambient audio signal and the local audio signal based on the determined first and second weights to produce a combined audio signal; and
providing an output signal based on the combined audio signal to the hearing device or sending the output signal to a receiver physically coupled to the hearing device.

20. The method of claim 19, wherein the mixing further comprises:
applying a gain to or attenuating the ambient audio signal or the local audio signal, wherein the applied gain or the attenuation are a function of the first weight or second weight.

21. The method of claim 19, wherein the first weight is also based on a noise floor estimate level of the ambient audio signal.

22. The method of claims 19, wherein the second weight is also based on a noise floor estimate level of the local audio signal.

23. The method of claim 19, further comprising:
attenuating the ambient audio signal when mixing it with the local audio signal by applying an attenuation that is a function of the second weight.

24. The method of claim 19, wherein mixing further comprises:
attenuating the ambient audio signal as long as the sound level of the ambient audio signal is louder than the sound level of the local audio signal.

25. The method of claim 19, wherein mixing further comprises:
attenuating the ambient audio signal when the remote audio source emits the ambient audio signal with a sound level that is higher than a first minimum threshold value.

26. The method of claim 25, wherein the attenuation is settable to a value that is a function of the noise floor estimate level of the ambient audio signal, wherein when the noise floor estimate level exceeds a threshold value, the attenuation increases proportionally.

27. The method of claim 26, wherein the threshold value is adjustable by a hearing device user through a user control on the hearing device or from a remote control.

28. The method of 19, wherein the ambient audio signal and the local audio signal are received simultaneously or offset in time.

29. The method of claim 19, wherein the first weight or the second weight are based on sound type classification or source type classification for the hearing device.

30. A non-transitory computer-readable medium storing instructions that when executed by a processor cause a device to perform operations, the operations comprising:
receiving wirelessly an ambient audio signal from a remote audio source;
receiving a local audio signal, wherein the local audio signal is associated with a microphone physically coupled to a hearing device;
determining a first weight for the ambient audio signal and a second weight for the local audio signal based on a sound level difference between the ambient audio signal and the local audio signal,
wherein the first and second weights are dynamic;
mixing the ambient audio signal and the local audio signal based on the determined first and second weights to produce a combined audio signal; and
providing an output signal based on the combined audio signal to the hearing device or sending the output signal to a receiver physically coupled to the hearing device.

31. The non-transitory computer-readable medium of claim 30, wherein the operations further comprise:
attenuating the ambient audio signal when mixing it with the local audio signal by applying an attenuation that is a function of the first weight to obtain an attenuated ambient audio signal.

32. The non-transitory computer-readable medium of claim 30, wherein the second weight is also based on a noise floor estimate level of the local audio signal.

33. The non-transitory computer-readable medium of claim 30, wherein the second weight is also based on detecting an own voice signal at the hearing device, wherein the own voice signal indicates the hearing device user is speaking.

34. A hearing device, comprising:
a transceiver configured to receive an ambient audio signal from an alternative audio source;
a microphone configured to provide a local audio signal, wherein local audio signal includes own voice information;
an audio signal processing unit comprising:
a weighting unit configured to determine weights of the ambient audio signal and the local audio signal based on a difference between a sound level difference between the ambient audio signal and the local audio,
a mixing unit configured to mix the ambient audio signal and the local audio signal based on the weights,
wherein the audio signal processing unit is configured to generate an output signal based on the instructions; and
a receiver configured to provide the output signal.

35. The hearing device of claim 34, wherein the receiver is a loudspeaker.

36. The hearing device of claim 34, wherein the audio signal processing unit is further configured to determine a noise floor estimate level of the ambient audio signal.
